(19) United States
(12) Patent Application Publication
(10) Pub. No.: US 2008/0099056 A1
(43) Pub. Date: May 1, 2008

(54) Method of using an anti-stick coating to reduce dirt accumulation

(76) Inventors: Atanu Adhvaryu, Peoria, IL (US); Ronald O. Groth, Metamora, IL (US); Andrew Neil McGilvray, East Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/589,759

(22) Filed: Oct. 31, 2006

(51) Int. Cl. C23G 5/00; B08B 7/00

(52) U.S. Cl. 134/40; 134/42

(57) ABSTRACT

Method of Using an Anti-Stick Coating to Reduce Dirt Accumulation The present disclosure is directed to a method of reducing dirt buildup on a machine surface. The method involves applying a sacrificial layer of an oil-based liquid on the surface and allowing dirt accumulation on the surface. The accumulated dirt along with the oil-based liquid is then removed.

### TECHNICAL FIELD

The present disclosure relates generally to a method of using a liquid coating, and more particularly, to a method of using a liquid coating to prevent dirt accumulation.

### BACKGROUND

Off-highway vehicles typically operate on terrain that contains loose and wet soil, mud, and other debris (dirt). During operation, some of this dirt gets accumulated on the surfaces of the vehicles. During subsequent operation of the vehicle, more dirt collects on the vehicle surface. Over time the dirt hardens on the vehicle surface. Eventually, the accumulated dirt is cleaned during periodic maintenance stops.

Accumulation of dirt and the resulting increase in vehicle weight decreases the fuel efficiency of the vehicle. In addition, accumulated dirt may impede the normal operation of exposed mechanisms of the vehicle. For instance, hardened accumulated dirt may interfere with the functioning of exposed levers on the underside of the vehicle. In addition, accumulated hardened dirt on the vehicle surfaces increases the time the vehicle will have to spend in the wash bay, thereby increasing the non productive time of the vehicle.

A coating used to repel dust is described in U.S. Pat. No. 6,949,271 B2 issued to Shannon et al. (hereinafter the '271 patent). The '271 patent discloses an anti-static “polymeric film forming composition” that is coated on a vehicle surface and dried to form a protective film or barrier that is repellant to dust and other light weight debris. The coating material of the '271 patent has a surface tension less than 25 milli-newtons per meter and a viscosity preferably less than 100 centipoise at room temperature. The coating material is sprayed or wiped on a surface and the excess material ia removed to leave a coating that dries to form a protective barrier film. The composition is dried by the application of heat or permitted to air-dry under ambient conditions. The coating material of the '271 patent may be applied to automotive surfaces, optical surfaces, retail product packaging, furniture, and other surfaces where dust is a problem. The polymeric film of the '271 patent relies on low surface energy to repel dust.

While the polymeric film of the '271 patent may be effective for repelling dust off a surface, it may have several limitations and drawbacks for application in an off-highway environment. For example, it is unclear if the low surface energy of the polymeric coating will prevent or reduce wet mud that is splashed on a vehicle surface from adhering to it. For the polymeric film of the '271 patent to repel dust off the surface, the surface of the film should be exposed to the dust. However, a layer of wet mud that is splashed on the surface may cover the film surface and prevent further repulsion of dust. Also, due to wear resulting from repeated contact with dirt and other debris, the protective film of the '271 patent may lose its effectiveness over time. In addition, application of the protective coating may involve drying steps that increase the cost of the process.

The present disclosure is directed at overcoming one or more of the shortcomings of the prior art anti-stick coatings.

### SUMMARY OF THE INVENTION

In one aspect, the present disclosure is directed to a method of reducing dirt buildup on a machine surface. The method involves applying a sacrificial layer of an oil-based liquid on the surface and allowing dirt accumulation on the surface. The accumulated dirt along with the oil-based liquid is then removed.

In another aspect, the present disclosure is directed to a method of reducing dirt buildup on an undercarriage of a machine. The method involves applying a sacrificial layer of an oil-based liquid on the undercarriage. The machine is then operated in an environment where dirt will accumulate on the undercarriage. The oil-based liquid is then washed off during machine cleaning, and a sacrificial layer of the oil-based liquid is reapplied on the undercarriage.

In yet another aspect, the present disclosure is directed to a method of operating a machine. The method involves washing the machine and coating an undercarriage of the machine with a liquid having viscosity in the range of about 175 to about 8700 centistokes at 40° C. The machine is then operated in an environment containing dirt, and the liquid coating is removed during the washing of the machine.

### BRIEF DESCRIPTION OF THE DRAWINGS

FIG. 1 is a diagrammatic illustration of an exemplary application of an anti-stick coating to reduce dirt accumulation.

FIG. 2 is a flow chart illustrating a method of using the anti-stick coating of FIG. 1 to reduce dirt accumulation.

### DETAILED DESCRIPTION

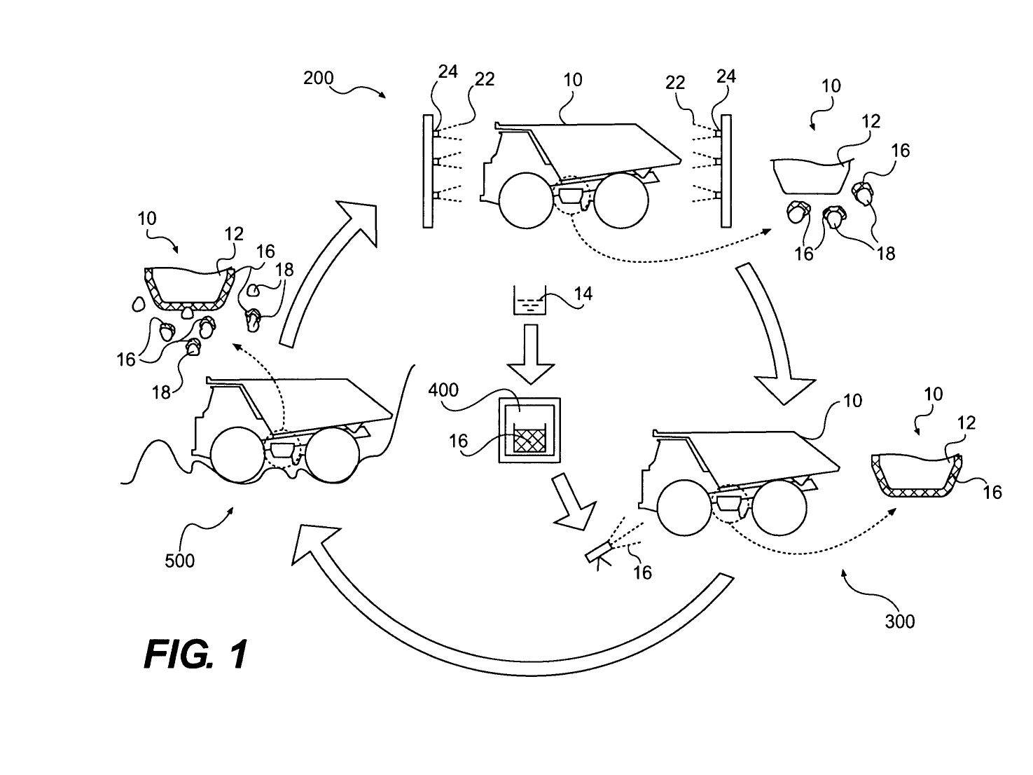

FIG. 1 illustrates the use of an anti-stick coating to reduce dirt accumulation in an exemplary machine 10. Machine 10 may embody a fixed or mobile machine that performs some type of operation associated with an industry. Such a machine could be used for mining, construction, farming, transportation, or any other industry known in the art. For example, machine 10 may be an excavator that operates at a road construction site.

As part its routine operation, machine 10 may undergo periodic cleaning. The cleaning process 200 may take place in an automatic wash bay or the machine 10 may be cleaned manually. A cleaning solution 22, such as water, soap solution, or solvent, may be sprayed on the machine 10 through nozzles 24 to remove accumulated dirt 18 from the surface 12 of the machine 10. The dirt 18 may include wet/dry mud, sand, dust, debris, grime and other material that may be found in the operating site 500 of the machine 10. In addition to dirt, the cleaning process 200 may also remove residual anti-stick coating 16 from the surface 12 of the machine 10.

After cleaning 200, the machine 10 may be taken to a coating station 300. A new anti-stick coating 16 may be applied to any surface 12 of the machine 10 at the coating station 300. Any application process suitable for applying a fluid on the surface 12 of a machine 10 may be used to apply the anti-stick coating 16. For instance, in some applications, the coating 16 may be sprayed on the surface 12 of the machine 10. In some other applications, the coating 16 may be painted or brushed on the surface 12 of the machine 10. The coating 16 may form a conformal coating on the surface 12 of the machine 10. A conformal coating is a coating that substantially conforms to the shape of the underlying surface 12. The coating application process may be manual or automatic. In some cases, the cleaning and coating processes may be combined. In such a case, the anti-stick coating 16 may be sprayed or brushed on to the surface 12 using the nozzles 24, after dirt 18 and the previously applied anti-stick coating 16 are removed during the cleaning process 200.

The anti-stick coating 16 may be formed by conversion of a low viscosity liquid coating 14 to a higher viscosity anti-stick coating 16 by exposing it to an ambient 400. For example, the anti-stick coating 16 may be formed by polymerization of seed oils by high temperature exposure. In this case, the liquid coating 14 is seed oil, the conversion process is polymerization, and the ambient 400 is the high temperature. Polymerization is the process whereby the smaller molecules of the liquid coating 14 link together to form larger molecules (or networks) which may have different properties. For example, polymerization of the liquid coating 14 may increase its viscosity. The ambient 400 may include a controlled temperature environment, such as room temperature, high temperature environment, or an inert atmosphere. In some applications, the exposure time of the liquid coating 14 in the ambient 400 may be varied to control the properties of the resulting anti-stick coating 16. It is contemplated that the anti-stick coating 16 may be made of environmentally safe materials.

Specialty chemicals may be added as additives to the liquid coating 14 to enhance its performance for a specific application. For instance, a corrosion inhibitor such as metal dithiophosphates, metal dithiocarbamates, metal sulfonates, thiadiazoles, sulfurized terpenes or similar compounds may be added to the liquid coating 14 to improve corrosion resistance of the surface 12. Rust inhibitors, such as metal sulfonates, alkylamines, alkyl amine phosphates, alkenylsuccinic acids, fatty acids, acid phosphate esters, or similar compounds may be added to prevent rusting of the surface 12. Metal deactivators, such as metal dithiophosphates, aromatic amines and metal phenates, or similar compounds may also be added to form protective film on the surface 12 to inhibit corrosion reactions. Chemicals may also be added to improve the properties of the liquid coating 14 and/or the anti-stick coating 16. For example, pour point depressants, such as polymethacrylates, polyfumarates, polystyrene esters, alkylsilicates, polyacrylamides, alkylated naphthalenes and oligomerized alkyl phenols, or similar compounds may be added to the liquid coating 14 to prevent freezing in low temperature applications. Tackiness agents, such as polyacrylates, resins, polybutenes, metal fatty acid soap complexes, or similar compounds may be added to improve adhesive quantities of the liquid coating 14 and the anti-stick coating 16. Viscosity improvers, such as polyisobutylene, polymethacrylates, styrene-diene copolymers, styrene polyesters, polyacrylates, olefin copolymers, or similar compounds may also be added to retard loss of viscosity at high temperatures.

It is contemplated that in some applications, the liquid coating 14 may be applied to the surface 12 before being converted to the anti-stick coating 16. In this case, the surface 12 may be exposed to the ambient 400 to convert the liquid coating 14 into the anti-stick coating 16.

After the anti-stick coating 16 is applied to the surface 12 of the machine 10, the machine 10 may return to its operating site 500 for routine operations. Routine operations may include any operation that the machine 10 performs. For example, routine operations for a road construction vehicle may involve operations in an road construction site. During operations, dirt 18 may be splashed on, or generally land on, the surface 12 of the machine 10. The anti-stick coating 16 may substantially cover the surface 12 of the machine 10. Some of the dirt 18 that is splashed on the surface 12 may not stick to the surface 12. Some dirt 18 may stick but fall off the surface 12, while some of the splashed dirt 18 may stick to the surface 12. The anti-stick coating 16 may provide a fluid film barrier to dirt 18 sticking on the surface 12. Therefore, some of the dirt 18 may get deposited on the anti-stick coating 16. The anti-stick coating 16 may provide a lubrication effect to the deposited dirt 18 causing some of the deposited dirt 18 to slide off the surface 12 of the machine 10. A portion of the ant-stick coating 16 may also be attached to the dirt 18 that slides off. Therefore, some of the anti-stick coating 16 may be lost from the surface 12 along with the dirt 18. Eventually enough of the anti-stick coating 16 may be lost from the surface 12, that the amount of dirt 18 that drops off from the surface 12 decreases, and the dirt 18 starts to accumulate on the surface 12. Thus the anti-stick coating 16 may function as a sacrificial coating to delay dirt 18 build up on the vehicle surface.

After a period of operation in the operating site 500, the machine 10 may be taken back for cleaning 200. The cleaning 200 may be part of routine periodic maintenance or the machine 10 may be taken for cleaning 200 based upon some other criterion. For instance, the machine 10 may be taken for cleaning 200 when there is a significant amount of dirt 18 stuck to the surface 12. During cleaning 200, the dirt 18 may be washed away along with the residual anti-stick coating 16 attached to the surface 12. The removal of the accumulated dirt 18 from the surface 12 of the machine 10 may be easier due to the presence of the anti-stick coating 16.

### INDUSTRIAL APPLICABILITY

The disclosed method of using a sacrificial layer of anti-stick coating to reduce dirt accumulation may be applied to any machine or machine 10 that performs any type of operation. For example, the disclosed method may be used to reduce dirt accumulation in off-highway trucks used in mining, and dirt accumulation in automobiles used on paved roads. The method uses a sacrificial layer of anti-stick coating 16 that may be applied to any surface 12 of a machine 10. The anti-stick coating 16 may act as a barrier layer to prevent the attachment of dirt directly on the surface 12 of the machine 10. Due to the presence of the anti-stick coating 16, the dirt 18 may get accumulated on the coating 16 rather than on the surface 12 of the machine 10. Some of the dirt 18 may slide off the anti-stick coating 16 along with a portion of the anti-stick coating 16. Consequently, dirt 18 accumulation on the surface 12 will be reduced. The anti-stick coating 16 may also enable easy removal of the accumulated dirt 18 from the surface 12 of the machine 10 during routine cleaning 200, thereby reducing wash time. The anti-stick coating 16 may get washed off along with the accumulated dirt 18 during cleaning 200. The presence of the anti-stick coating 16 under the accumulated dirt may also enable easy removal of the solidified dirt by mechanical means, such as a scrub or an air blast, thereby reducing cleaning 200. The use of the anti-stick coating 16 may also provide additional benefits, such as anti-corrosion, anti-rust, and lubrication, to the surface 12. The method of reducing dirt accumulation on vehicles using a sacrificial layer of anti-stick coating 16 may provide substantial cost savings to the operators of the machine 10. Cost savings may be obtained by increase in vehicle fuel efficiency due to decreased weight of the accumulated dirt 18, and/or by reduced down time for cleaning the machine 10. Cost savings may also be obtained from reduced maintenance costs for replacing machine parts that are degraded/damaged by dirt. The method of using the anti-stick coating 16 to reduce dirt accumulation in a machine 10 will now be described.

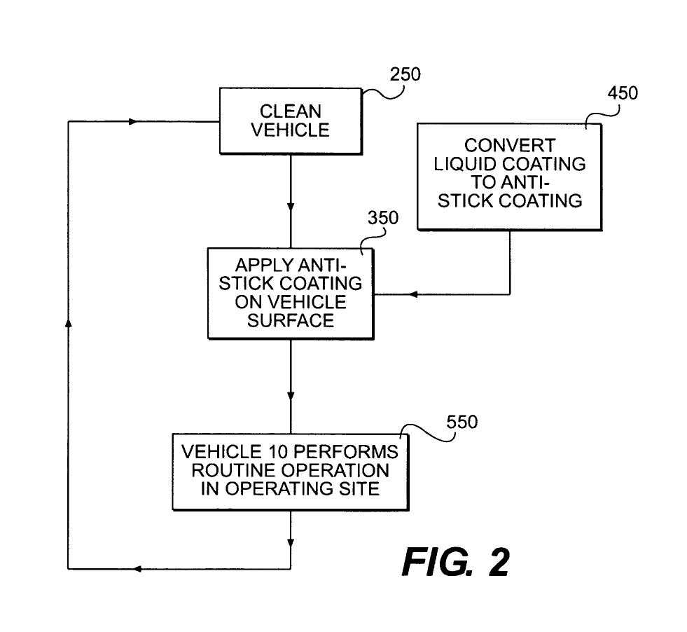

As illustrated in FIG. 2, the first step 250 is to clean the machine 10. Any cleaning process 200, such as an automatic wash or a manual wash, that is commonly used to clean the machine 10 can be used in this step. The vehicle may be cleaned using any cleaning solution 22, such as warm water, that is commonly used. It is also contemplated that different cleaning solutions may also be used in series to clean the machine 10. During the cleaning step accumulated dirt along with residual anti-stick coating 16 may be washed off the surface 12 of the machine 10.

The second step 450 is to convert the liquid coating 14 to the anti-stick coating 16. The conversion process may involve among others, polymerization of the liquid coating 14 in an ambient 400. The conversion process may increase the viscosity of the resulting anti-stick coating 16. In some applications, the viscosity of the anti-stick coating 16 may range from about 175 to about 8700 centistrokes at 40° C. In some other applications, a viscosity in the range about 900 to about 3000 centistokes at 40° C. may be formed. One or more additives may be added to the liquid coating 14 and/or the anti-stick coating 16 to obtain specific properties. The second step 450 may be performed at any time. In some applications, the second step 450 may be eliminated and anti-stick coating 16 that was previously made may be used.

The third step 350 involves application of the anti-stick coating 16 on the surface 12 of the machine 10. The anti-stick coating 16 may be sprayed on the surface 12 of the machine 10 using a spray gun. In some applications, the anti-stick coating 16 may be brushed on the surface 12 of the machine 10. After application, the anti-stick coating 16 may form a conformal coating over the surface 12, and may substantially cover the entire surface 12. The anti-stick coating 16 may also be selectively applied to surfaces that are prone to dirt accumulation (for example, the undercarriage of a vehicle).

In the fourth step 550, the machine 10 may be sent to the operating site 500 to perform routine operations. During operations, dirt 18 may get deposited on the machine 10. Due to the presence of a layer of anti-stick coating on the vehicle surface, the dirt 18 may get attached to the surface of the anti-stick coating 16 rather than the surface 12 of the machine 10. Some of the dirt 18 may slide off the surface along with some of the anti-stick coating 16. Over time, more dirt 18 may get accumulated on the surface 12 of the machine 10.

When enough dirt 18 gets accumulated on the surface 12, the cleaning process 200 of the first step may be repeated. The machine 10 may also be send for cleaning 200 after a pre-determined time. During cleaning 200 the accumulated dirt 18 along with the remaining anti-stick coating 16 on the surface 12 of the machine 10 may be washed away.

The layer of anti-stick coating 16 reduces and delays dirt 18 build up on a vehicle surface 12 by causing some of the dirt to not adhere to the surface 12 and/or by causing the deposited dirt 18 to slide off the surface 12. As mentioned earlier, some of the anti-stick coating 16 may be lost with the dirt 18 that slides off the surface 12. When this dirt 18 slides off a fresh surface of the anti-stick coating 16 may be exposed to receive more dirt 18. Thus the anti-stick coating delays dirt accumulation on the vehicle surface 12. Over time a significant amount of the anti-stick coating 16 may be lost from some regions of the surface 12 that its effectiveness decreases. However, since only a small amount of the anti-stick coating 16 may be lost with the dirt 18, the anti-stick coating 16 may be effective for reducing dirt accumulation for a long period of time. Also, since a fresh layer of anti-stick coating 16 is applied after the machine 10 is cleaned, the effectiveness of the anti-stick coating 16 to reduce dirt 18 buildup can be restored. In addition, since no drying step is needed to form the anti-stick coating 16 layer, the cost and complexity of application is reduced.

It will be apparent to those skilled in the art that various modifications and variations can be made to the disclosed method. Other embodiments will be apparent to those skilled in the art from consideration of the specification and practice of the method of using an anti-stick coating 16 to reduce dirt accumulation. It is intended that the specification and examples be considered as exemplary only, with a true scope being indicated by the following claims and their equivalents.

What is claimed is:

1. A method of reducing dirt buildup on a machine surface comprising;
applying a sacrificial layer of an oil-based liquid on the surface;
allowing dirt accumulation on the surface; and
removing the accumulated dirt along with the oil-based liquid.

2. The method of claim 1, wherein applying the sacrificial layer of oil-based liquid includes producing the oil-based liquid.

3. The method of claim 1, wherein the oil-based liquid includes one or more of a corrosion inhibitor, rust inhibitor, metal deactivator, pour point depressant, tackiness agent and/or a viscosity improver.

4. The method of claim 1, wherein the oil-based liquid is a polymerized seed oil.

5. The method of claim 1, wherein the viscosity of the oil-based liquid is in the range of about 175 to about 8700 centistokes at 40° C.

6. The method of claim 1, wherein the viscosity of the oil-based liquid is in the range of about 900 to about 3000 centistokes at 40° C.

7. The method of claim 1, wherein applying the sacrificial layer includes applying the oil-based liquid to an undercarriage of the machine.

8. The method of claim 1, wherein removing the accumulated dirt includes washing the machine.

9. The method of claim 1, further including reapplying a sacrificial layer of the oil-based liquid on the surface after the removal of the accumulated dirt.

10. The method of claim 9 further including removing the reapplied sacrificial layer of the oil-based liquid and further reapplying a sacrificial layer of the oil-based liquid on the surface after the step of removing the reapplied sacrificial layer.

11. The method of claim 10, wherein applying the sacrificial layer, reapplying the sacrificial layer, and further reapplying the sacrificial layer are part of cleaning operations of the machine.

12. A method of reducing dirt buildup on an undercarriage of a machine comprising;
applying a sacrificial layer of an oil-based liquid on the undercarriage;
operating the machine in an environment where dirt will accumulate on the undercarriage;
washing off the oil-based liquid during machine cleaning; and
reapplying a sacrificial layer of the oil-based liquid on the undercarriage.

13. The method of claim 12, wherein the oil-based liquid has a viscosity in the range of about 175 to about 8700 centistokes at 40° C.

14. The method of claim 12, wherein the oil-based liquid includes one or more of a corrosion inhibitor, rust inhibitor, metal deactivator, pour point depressant, tackiness agent, and/or a viscosity improver.

15. The method of claim 12, wherein the oil-based liquid is a polymerized seed oil.

16. The method of claim 12, further including repeating the washing off of the oil-based liquid, and reapplying a sacrificial layer after dirt accumulates on the undercarriage of the machine.

17. A method of operating a machine;
washing the machine;
coating an undercarriage of the machine with a liquid having a viscosity in the range of about 175 to about 8700 centistokes at 40° C.;
operating the machine in an environment containing dirt; and
removing the liquid coating during the washing of the machine.

18. The method of claim 17 further including repeating the coating of the undercarriage, operating the machine, and removing the liquid coating after the step of washing the machine.

19. The method of claim 17, wherein the liquid includes one or more of a corrosion inhibitor, rust inhibitor, metal deactivator, pour point depressant, tackiness agent, and/or a viscosity improver.

20. The method of claim 17, wherein the liquid is a polymerized seed oil.
